(19) United States
(12) Patent Application Publication
(10) Pub. No.: US 2013/0050346 A1
(43) Pub. Date: Feb. 28, 2013

(54) METHOD OF MANUFACTURING ELECTROMECHANICAL TRANSDUCER FILM, METHOD OF MANUFACTURING ELECTROMECHANICAL TRANSDUCER ELEMENT, ELECTROMECHANICAL TRANSDUCER ELEMENT MANUFACTURED BY THE METHOD, DROPLET JET HEAD AND DROPLET JET APPARATUS

(71) Applicants: Atsushi TAKEUCHI, Kanagawa (JP); Osamu MACHIDA, Kanagawa (JP); Ryo TASHIRO, Kanagawa (JP); Masahiro YAGI, Kanagawa (JP); Dongsik JANG, Kanagawa (JP); Yoshinori BANDOH, Kanagawa (JP)

(72) Inventors: Atsushi TAKEUCHI, Kanagawa (JP); Osamu MACHIDA, Kanagawa (JP); Ryo TASHIRO, Kanagawa (JP); Masahiro YAGI, Kanagawa (JP); Dongsik JANG, Kanagawa (JP); Yoshinori BANDOH, Kanagawa (JP)

(73) Assignee: RICOH COMPANY, LTD., Tokyo (JP)

(21) Appl. No.: 13/596,128

(22) Filed: Aug. 28, 2012

(30) Foreign Application Priority Data
Aug. 31, 2011 (JP) 2011-188998
Aug. 17, 2012 (JP) 2012-180843

(51) Int. Cl. B41J 2/04; B05D 5/12; H02N 11/00

(52) U.S. Cl. 347/54; 310/300; 427/458

(57) ABSTRACT

An applying liquid is applied to a first electrode by ejecting from a nozzle the applying liquid including a raw material for forming an elecromechanical transducer film, and a film of the applying liquid applied onto the first electrode is dried. The dried film is thermally decomposed and crystallized. At this time, a voltage is applied to an accompanying droplet collecting electrode for collecting a small accompanying droplet accompanying a chief droplet. The accompanying droplet is electrostatically attracted and collected by the accompanying droplet collecting electrode before reaching the first electrode. At this time, the voltage is applied to the accompanying droplet collecting electrode by the voltage applying part after a predetermined period of time has elapsed from when a droplet of the applying liquid has been ejected from the nozzle.

### BACKGROUND OF THE INVENTION

1. Field of the Invention

The present invention relates to a method of manufacturing an elecromechanical transducer film, a method of manufacturing an elecromechanical transducer element, an elecromechanical transducer element manufactured by the method, a droplet jet head and a droplet jet apparatus.

2. Description of the Related Art

An elecromechanical transducer element having a configuration in which an elecromechanical transducer film is sandwiched by electrodes is used, for example, in an inkjet recording apparatus that includes a droplet jet head that ejects ink droplets, and forms an image by causing ink droplets to adhere to a medium while conveying the medium. Hereinafter, the medium may also be referred to as a “sheet of paper”, but the material of the medium is not limited. A “medium” may also be referred to as a to-be-recorded medium, a recording medium, a transfer material, a recording sheet of paper or the like. An “image forming apparatus” such as the above-mentioned inkjet recording apparatus means an apparatus that ejects liquid to a medium such as paper, thread, fibers, fabric/cloth, leather, metal, plastic, glass, wood or ceramics, and forms an image thereon. To “form an image” means not only giving an image having a meaning such as characters/letters, figures, or the like, onto a medium, but also giving an image having no particular meaning such as patterns for merely ejecting liquid). Further, “ink” is not limited to so-called “ink”, and thus, is not particularly limited as long as it has a form of liquid when being ejected. Thus, “ink” may be used as a general term of a liquid that may be a DNA sample, resist, a pattern material or the like, for example.

The above-mentioned “inkjet recording apparatus” includes nozzles for ejecting ink droplets. The ink jet recording apparatus further includes ejection chambers, pressurizing liquid chambers, pressure chambers and liquid chambers called ink flow path chambers, with which the nozzles communicate. The ink jet recording apparatus further includes pressure generation parts for ejecting liquid included in the liquid chambers. As the pressure generation parts, piezoelectric-type pressure generation parts are known in which elecromechanical transducer elements such as piezoelectric elements are used, the shapes of vibration plates that are included in wall surfaces of the ejection chambers are changed, and thus ink droplets are ejected. The elecromechanical transducer elements used in the piezoelectric-type pressure generation parts include lower electrodes (first electrodes); elecromechanical transducer layers; and upper electrodes (second electrodes), which are superposed together to form laminated films, respectively. Individual elecromechanical transducer elements are provided for the respective pressure chambers for generating pressure to eject ink droplets. Each elecromechanical transducer layer is formed as a result of a process of forming an elecromechanical transducer film being carried out plural times. The elecromechanical transducer film is made of lead zirconate titanate (PZT) ceramics or the like. Since lead zirconate titanate (PZT) ceramics include plural metallic oxides as chief ingredients, they are generally called “metal oxide composites”.

As a method of manufacturing such an elecromechanical transducer film, a sputtering method, a sol-gel method, a CVD method, a laser ablation method or the like may be cited. Thereamong, a sol-gel method in which a film is formed by processes of applying sol, drying, degreasing and firing may be superior in controllability of a crystal state. As a method of forming an elecromechanical transducer film using the sol-gel method, methods described in patent reference No. 1 (Japanese Laid-Open Patent Application No. 2003-297825) and patent reference No. 2 (Japanese Laid-Open Patent Application No. 2006-176385) are known. According to the methods of patent references Nos. 1 and 2, a desired pattern is formed as a result of an applying liquid being applied at a predetermined area on an electrode using a droplet ejection method of ejecting droplets including a raw material for forming an elecromechanical transducer film from a nozzle. Then, the film of the applying liquid that has been applied on the electrode is dried, the film of the applying liquid thus dried is then thermally decomposed and is crystallized, and thus, an electromechanical transducer film is formed.

However, an applying liquid including a raw material for forming an elecromechanical transducer film has lower viscosity than an ink liquid that is used in a common inkjet recording apparatus. Thus, when a chief droplet of the applying liquid is ejected from a nozzle, a very small accompanying droplet having a size smaller than the chief droplet may be easily generated. The accompanying droplet may fly toward an electrode in a form of mist, for example, while receiving air resistance, and may adhere to the electrode at a position other than a predetermined area as an unnecessary droplet.

A method described in patent reference No. 3 (Japanese Patent No. 4622571) is known for collecting such accompanying droplets to solve the problem. According to the collecting method of patent reference No. 3, a potential difference is generated between a nozzle surface of a nozzle plate and a first electrode that is an opposite electrode opposite to the nozzle plate. An electric field is generated between the nozzle surface and the first electrode. Thus, when an applying liquid is ejected toward the first electrode from the nozzle to a space having the electric field, polarization in one direction occurs in the applying droplet. Thus, ion molecules having the polarity opposite to the first electrode gather at the leading end of the flying applying droplet that has a column-like shape, and ion molecules having the polarity opposite to the nozzle plate gather at the back end of the flying applying liquid. Then, the leading end of the droplet is attracted by the first electrode electrostatically, and the back end of the droplet is attracted by the nozzle plate electrostatically. Thus, the flying droplet is divided into the leading end side droplet and the back end side droplet. The leading end side droplet of the applying droplet corresponds to the above-mentioned chief droplet, and moves to the first electrode. On the other hand, the divided back end side droplet of the applying droplet corresponds to the above-mentioned accompanying droplet, and is electrostatically attracted toward an accompanying droplet collecting electrode to which a voltage of the polarity opposite to the accompanying droplet is applied by a voltage applying part that is provided near the nozzle. By this electrostatic attracting force, the accompanying droplet is collected before reaching the first electrode.

However, according to the collecting method of patent reference No. 3, the voltage is constantly applied to the accompanying droplet collecting electrode by the voltage applying part from the time of ejecting the applying liquid from the nozzle toward the first electrode to the time of the chief droplet of the applying liquid reaching the first electrode. Thus, the electric field is constantly generated between the accompanying droplet collecting electrode and the first electrode. Thus, other than the electric field between the nozzle surface and the first electrode, the electric field exists between the accompanying droplet collecting electrode and the first electrode. Then, the polarization in one direction occurs in the chief droplet when the accompanying droplet has been divided from the applied droplet, and ion molecules having the polarity opposite to the nozzle plate and the droplet collecting electrode gather at the back end of the chief droplet. Thus, the chief droplet, which is to be electrostatically attracted by the first electrode, is also electrostatically attracted by the accompanying droplet collecting electrode. Further, there are many cases where the division into the chief droplet and the accompanying droplet occurs near the nozzle surface. Thus, since the electric potential difference is constantly generated between the accompanying droplet collecting electrode and the nozzle plate, the column-like droplet before being divided (applied droplet) is influenced not only by the first electrode but also by the electric field of the accompanying droplet collecting electrode, and electrification of the accompanying droplet may be remarkably weakened. As a result, the force by which the accompanying droplet is electrostatically attracted by the accompanying droplet collecting electrode may be weakened, and the movement of the accompanying droplet may not be able to be controlled. Thus, the accompanying droplet may easily adhere around the nozzle, and a flying direction of a droplet may be easily bent. As a result, the landing position of the chief droplet may vary, and it may be difficult to form a desired pattern on the first electrode.

### SUMMARY OF THE INVENTION

According to one aspect, a method of manufacturing an electromechanical transducer film includes selectively applying an applying liquid at a predetermined area on a first electrode by a droplet ejection method of ejecting from a nozzle the applying liquid including a raw material for forming the elecromechanical transducer film; drying a film of the applying liquid applied onto the first electrode; and thermally decomposing and crystallizing the dried film of the applying liquid.

The above-mentioned applying the applying liquid includes applying a voltage to an accompanying droplet collecting electrode that collects a very small accompanying droplet that accompanies a chief droplet of the applying liquid ejected from the nozzle. The voltage has a polarity opposite to the accompanying droplet and is applied to the accompanying droplet collecting electrode by a voltage applying part. Thus, the accompanying droplet is electrostatically attracted by the accompanying droplet collecting electrode and is thus collected before reaching the first electrode.

The applying the voltage to the accompanying droplet collecting electrode and collecting the accompanying droplet include applying a voltage to the accompanying droplet collecting electrode by the voltage applying part after a predetermined period of time has elapsed from when a droplet of the applying liquid has been ejected from the nozzle, and collecting the accompanying droplet.

Other objects, features and advantages of the present invention will become more apparent from the following detailed description when read in conjunction with the accompanying drawings.

### BRIEF DESCRIPTION OF THE DRAWINGS

FIGS. 1A, 1B, 1C, 1D, 1E and 1F are process sectional views showing a manufacturing process of an electromechanical transducer film according to the embodiments;

FIG. 2 is a sectional view showing a configuration example of a droplet jet head that applies a PZT precursor solution;

FIGS. 3, 4, 5, 6, 7 and 8 are sectional views showing a process of applying a PZT precursor solution using a droplet jet head;

FIGS. 9A and 9B are sectional views showing switching control of a voltage applied to a mist collecting electrode;

FIGS. 10A and 10B are waveforms showing an ejection synchronization signal and a mist collecting electrode applying voltage (mist collecting electrode electric potential);

FIG. 11 is a perspective view showing a droplet jet applying apparatus that has a droplet jet head according to the embodiments mounted thereon;

FIG. 12 is a characteristic diagram showing one example of a P-E hysteresis curve of a PZT film manufactured by an example of the embodiments;

FIGS. 13A and 13B illustrate respective states of a contact angle of pure water on an electrode exposed surface from which a SAM film has been removed and a surface on which the SAM film is still placed;

FIG. 14 shows a general configuration of an example of a droplet jet head using an electromechanical transducer element that is manufactured by a method according to the embodiments;

FIG. 15 shows a general configuration of an example in which plural droplet jet heads each shown in FIG. 14 are arranged;

FIG. 16 shows a general configuration of an example of a droplet jet apparatus that can use an electromechanical transducer element that is manufactured by a method according to the embodiments; and

FIG. 17 is a general perspective see-through view showing the droplet jet apparatus of FIG. 16.

### DETAILED DESCRIPTION OF THE EMBODIMENTS

An object of the embodiments is to provide a method of manufacturing an electromechanical transducer film, a method of manufacturing an electromechanical transducer element, an electromechanical transducer element manufactured by the method, a droplet jet head and a droplet jet apparatus. In the method of manufacturing an electromechanical transducer film, it is possible to prevent an unnecessary droplet from adhering to an electrode when ejecting an applying liquid including a raw material for forming the electromechanical transducer film from a nozzle and applying it to the electrode, and also, it is possible to form the electromechanical transducer film having a desired pattern.

Below, the embodiments will be described.

It is noted that in the embodiments described below, an electromechanical transducer element having an electromechanical transducer film of a horizontal vibration (bending mode) type using deformation of piezoelectric constant d31 will be used as an example. However, embodiments are not limited to those that use electromechanical transducer films having this type, and may be those that use electromechanical transducer films having other types.

In a case where an electromechanical transducer film is a PZT film, a PZT precursor solution may be used which is synthesized using, as starting materials, lead acetate trihydrate, titanium isopropoxide and zirconium normal butoxide. Crystal water of lead acetate is dissolved in methoxyethanol, and then, is dehydrated to obtain a methoxyethanol solution. With respect to stoichiometric composition, the amount of lead is made to exceed by 10 mol %. This is for the purpose of avoiding degradation in crystal properties which degradation may occur due to a removal of lead during heat treatment. Titanium isopropoxide and zirconium normal butoxide are dissolved in methoxyethanol, alcohol exchange reaction and esterification reaction are allowed to proceed, and the titanium isopropoxide and zirconium normal butoxide are uniformly mixed with the above-mentioned methoxyethanol solution in which lead acetate has been dissolved. Thus, the PZT precursor solution can be synthesized. The PZT concentration of the PZT precursor solution is made to be, for example, 0.1 mol/liter. In first, second and third examples of the embodiments described later, the PZT precursor solution (in the description of the examples of embodiments, referred to as “PZT precursor solution A”) synthesized in the above-described method was used.

Further, a PZT precursor solution, for a case where an electromechanical transducer film is a PZT film, may also be obtained as a uniform solution obtained from using lead acetate and a zirconium alkoxide and titanium alkoxide compound as starting materials and dissolving them in methoxyethanol to be used as a common solvent, as described in non-patent reference No. 1 (K. D. Budd, S. K. Dey and D. A. Payne, Proc. Brit. Ceram. Soc. 36, 107 (1985)). The above-mentioned PZT precursor solution is also called a “sol-gel solution”.

PZT is a solid solution of lead zirconate (PbZrO₃) and lead titanate (PbTiO₃), and has different properties depending on their ratio. Generally speaking, a composition that exhibits a superior piezoelectric property is one having a ratio of PbZrO₃ and PbTiO₃ being 53:47, has a chemical formula of Pb(Zr0.53, Ti0.47)O₃, and is generally referred to as PZT(53/47). The starting materials of lead acetate and a zirconium alkoxide and titanium alkoxide compound will be weighed according to this chemical formula. A metal alkoxide compound is easily hydrolyzed by moisture in the atmosphere, and thus, a stabilization agent such as acetylacetone, acetic acid, diethanolamine and/or the like may be added to the precursor solution of a proper quantity.

As a complex oxide other than PZT, barium titanate or the like may be cited. In this case, a barium titanate precursor solution may also be prepared as a result of using as a starting material a barium alkoxide and titanium alkoxide compound and dissolving them in a common solvent.

Further, in a case of obtaining a patterned PZT film as an electromechanical transducer film on a surface of a first electrode on a substrate used as a ground, a patterned PZT film can be obtained as a result of forming a coated film by applying the above-mentioned solution as an applying liquid using a droplet ejection method, and carrying out respective processes of heat treatment, i.e., solvent drying, thermal decomposition and crystallization. Transformation from the coated film to the crystallized film is accompanied by volume shrinkage. Thus, in order to obtain a crack-free film, it is preferable to obtain a film thickness of 100 nm or less in 1 time of a process. Then, it is preferable to adjust the precursor concentration into a proper value from the viewpoint of a relationship between the area of the elecromechanical transducer film to be formed and the amount of the PZT precursor solution to be applied. Further, in a case where the elecromechanical transducer film is used in an elecromechanical transducer element of a droplet jet apparatus, 1 μm through 2 μm is required as the film thickness of the PZT film. In order to obtain such a film thickness, the process is to be repeated ten and several times.

Further, in a case of forming a patterned electromechanical transducer film by a sol-gel method, a PZT precursor solution is applied at a predetermined area by controlling wettability of a substrate used as a ground. This method uses a phenomenon of alkanethiol's self assembling on a specific metal as shown in non-patent reference No. 2 (A. Kumar and G. M. Whitesides, Appl. Phys. Lett., 63, 2002 (1993)). First, a Self Assembled Monolayer (SAM) film of thiol is formed on a surface of a platinum-group metal of a substrate. Since the SAM film has alkyl groups arranged thereon, it is hydrophobic. The SAM film can be patterned by known photolithography etching using photoresist, for example. Even after the resist has been removed, the SAM film still remains, and this part is hydrophobic. On the other hand, at the part from which the SAM film has been removed, the platinum surface is exposed, and thus, this part is hydrophilic. By using this contrast of surface energy, it is possible to place the PZT precursor solution at an appropriate part. According to the embodiments, the above-mentioned SAM film is formed selectively at an area at which the above-mentioned PZT precursor solution is not to be placed. After that, the PZT precursor solution is selectively applied by coating (inkjet coating) according to a droplet ejection method by which the consumption amount of the PZT precursor solution can be reduced, as will be described below.

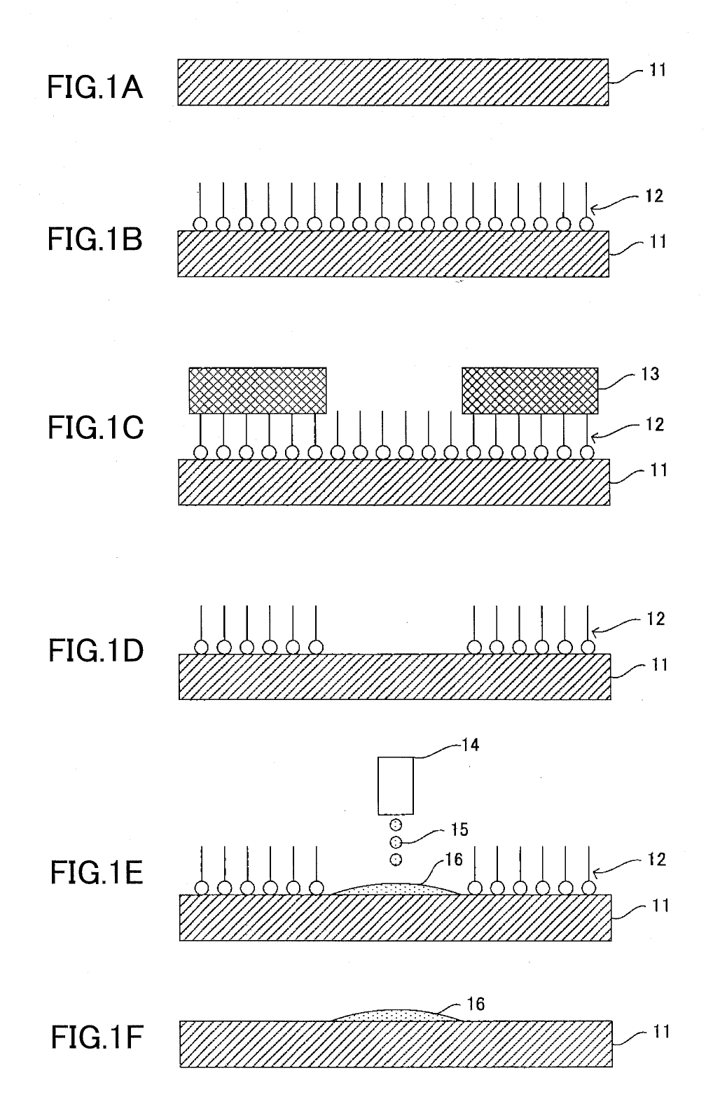

FIGS. 1A, 1B, 1C, 1D, 1E and 1F are process sectional views showing a process of manufacturing an electromechanical transducer element including forming of an elecromechanical transducer film according to the embodiments. A platinum electrode made of a platinum-group metal (not shown) as a first electrode that is superior in reactivity with thiol is formed by, for example, a sputtering method, on a surface (top surface) of a substrate 11 shown in FIG. 1A. On the surface of the platinum electrode, a SAM film 12 is formed as shown in FIG. 1B. The SAM film 12 is obtained from dipping the substrate 11 in an alkanethiol liquid and thus causing self assembling. In this example, an alkanethiol liquid is used in which alkanethiol molecules of CH₃(CH₂)—SH have been dissolved by a predetermined concentration (for example, several mol/l) in a common solvent (alcohol, acetone, toluene or the like). The substrate 11 is dipped in the alkanethiol liquid, and then, is taken out after the elapse of predetermined hours. Then, extra molecules are removed by displacement washing using a solvent, and the substrate 11 is dried. Thereby, it is possible to form the SAM film 12 on the surface of the platinum electrode. Next, as shown in FIG. 1C, a pattern of photoresist 13 is formed by photolithography, the SAM film 12 is removed by dry etching (for example, irradiation of oxygen plasma or irradiation of UV light) the photoresist 13 that has been used for etching is removed, as shown in FIG. 1D, and thus, patterning of the SAM film 12 is finished. The SAM film 12 thus formed has a contact angle of, for example, 92 degrees with respect to pure water, and exhibits a hydrophobic property. On the other hand, the surface of the platinum electrode of the substrate 11 exposed as a result of the SAM film 12 being thus removed has a contact angle of, for example, 54 degrees with respect to pure water, and exhibits a hydrophilic property.

Next, after the process of FIGS. 1A, 1B, 1C and 1D are carried out, a PZT precursor solution 15 is applied by a droplet ejection method of ejecting droplets of the PZT precursor solution 15 from a nozzle, specifically, by a droplet jet head 14 (see FIG. 1E). In the applying the PZT precursor solution 15, forming of a PZT film on the SAM film 12 that is the hydrophobic part is not easily allowed, and only forming of a PZT film on the hydrophilic part from which the SAM film 12 has been thus removed is easily allowed, because of this contrast of surface energy. Finally, an elecromechanical transducer film is obtained as a result of respective processes of heat treatment, i.e., solvent drying, thermal decomposition and crystallization being carried out (see FIG. 1F).

In the above-described method of FIGS. 1A, 1B, 1C, 1D, 1E and 1F, the electromechanical transducer film having the predetermined film thickness is obtained by execution of the processes of FIGS. 1A, 1B, 1C and 1D, the applying of the PZT precursor solution by the droplet ejection method of FIG. 1E, and the respective processes of heat treatment, i.e., solvent drying, thermal decomposition and crystallization of FIG. 1F, 1 time each. However, it is also possible to obtain an elecromechanical transducer film having a predetermined film thickness by repeating the processes of FIGS. 1A, 1B, 1C and 1D, the applying of the PZT precursor solution by the droplet ejection method of FIG. 1E, and the respective processes of heat treatment, i.e., solvent drying, thermal decomposition and crystallization of FIG. 1F, a predetermined number of times (2 or more times), and thus superposing plural electromechanical transducer films together in layers each having a film thickness that can be determined to be smaller. In this case, it is possible to more positively avoid appearing of cracks in the electromechanical transducer film.

Further, in the method of FIGS. 1A, 1B, 1C, 1D, 1E and 1F, surface modification is carried out to change a surface of the first electrode other than a predetermined area to place the PZT precursor solution into a hydrophobic surface using the SAM film. However, in a case where the surface of the first electrode is originally a hydrophobic surface, surface modification may be carried out to change the surface of a predetermined area to place the PZT precursor solution onto a hydrophilic surface.

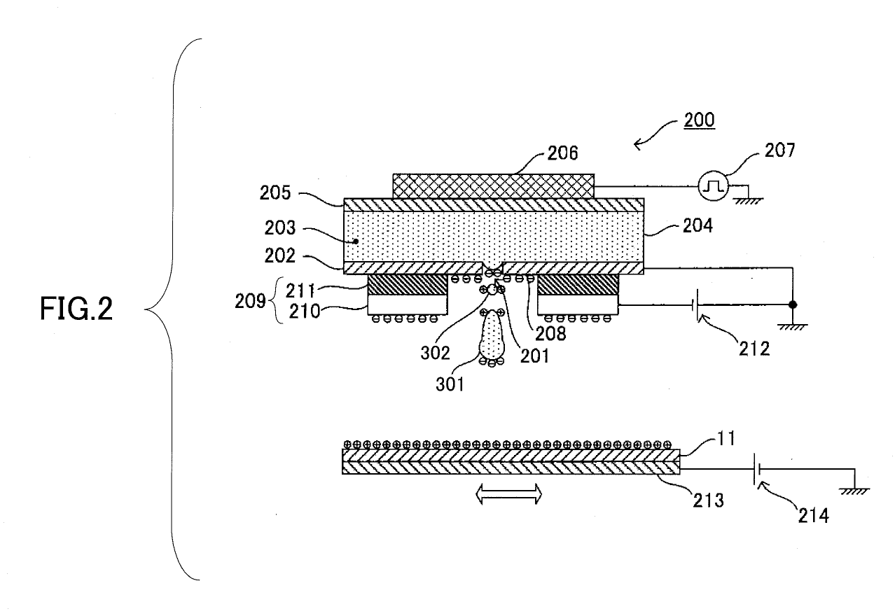

FIG. 2 is a sectional view showing one configuration example of the droplet jet head to apply the PZT precursor solution. As shown in FIG. 2, the droplet jet head 200 includes a nozzle plate 202 having a nozzle hole 201 formed therein and at least the surface of the nozzle plate 202 has an electrically-conductive property. The droplet jet head 200 further includes a vibration plate 205 provided to face the nozzle plate 202 to form a liquid chamber 204 having the applying liquid (PZT precursor solution) 203. The droplet jet head 200 further includes a piezoelectric element (for example, PZT) 206 stuck on the surface of the vibration plate 205 reverse to the liquid chamber 205 to oppose to the nozzle hole 201. Further, the droplet jet head 200 includes an ejection driving power source 207 as a voltage applying part that applies an ejection driving signal including a pulsed voltage to the piezoelectric element 206 based on a predetermined control program and control data. When the ejection driving signal is applied to the piezoelectric element 206 by the ejection driving power source 207, the piezoelectric element 206 is deformed, and along therewith, the vibration plate 205 is deformed toward the liquid chamber 204. Thereby, the inside of the liquid chamber 204 is pressurized, and a predetermined amount of the applying liquid (PZT precursor solution) 203 is ejected through the nozzle hole 201.

Further, the droplet jet head 200 has a mist collecting electrode 209 as a collecting electrode on a nozzle surface (the surface reverse to the liquid chamber 204) 208 of the nozzle plate 202 near the nozzle hole 201. The mist collecting electrode 209 has a projected shape and slightly projects from the nozzle surface 208. The mist collecting electrode 209 includes an electric conductor layer 210 and an insulation layer 211 that is provided between the electric conductor layer 210 and the nozzle surface 208 and is made of an electrically insulating material. In this example, the nozzle plate 202 is grounded and the electric conductor layer 210 of the mist collecting electrode 209 is connected to an applying power source 212. The applying power source 212 applies a predetermined electric potential (for example, −50 through −10 V) to the mist collecting electrode 209 so that the mist collecting electrode 209 generates a predetermined electric field. Thus, the applying power source 212 is provided between the electric conductor layer 210 and ground. Further, the height of the mist collecting electrode 209 from the nozzle surface 208 is preferably less than or equal to 0.2 mm since a distance between a nozzle surface and a printing target (in the embodiments, corresponding to the substrate 11 to which the PZT precursor solution is applied) in a common inkjet recording apparatus when printing is carried out is 0.5 through 1 mm. The thickness of the insulation layer 211 is preferably greater than or equal to 50 μm although it depends on the electric potential to be applied to the mist collecting electrode 209 and the insulating material. An electric charge deflection electrode 213 is attached to the back side of the substrate 11, and a voltage having polarity opposite to the mist collecting electrode 209 is applied to the electric charge deflection electrode 213 when the PZT precursor solution is applied by an applying power source 214. For example, in a case where the distance between the nozzle surface 208 and the substrate 11 is 0.5 mm, the voltage of the electric charge deflection electrode 213 is preferably higher than or equal to +50 V.

The solvent for dissolving the PZT precursor is limited. Thus, in order to stably eject from the drop jet head 200 the PZT precursor solution as the applying liquid to be used in the manufacturing method according to the embodiments, ingenuity may be required in determining the waveform of the ejection driving signal to be applied to the piezoelectric element 206, for example. However, there may be a limit to a method of achieving stable ejection of droplets by optimizing the waveform of the ejection driving signal. As shown in FIG. 2, when a certain amount of the PZT precursor solution 203 is ejected, an accompanying droplet 302 may be generated behind a main droplet (hereinafter, referred to as a “chief droplet”) 301. The accompanying droplet 302 has a volume smaller than the chief droplet 301 (for example, a thousandth of the chief droplet 301), and has a velocity lower than that of the chief droplet 301. Hereinafter, since the accompanying droplet 302 is generated like mist, the accompanying droplet 302 will be referred to as a “mist droplet” 302.

Since the mist droplet 302 has the velocity lower than the chief droplet 301, the mist droplet 302 will land at a position other than an area at which the PZT precursor solution is to be applied, and thus may cause a pattern failure. Thus, according to the embodiments, the mist droplet 302 is electrified, and also, a predetermined electric field is generated near the nozzle hole 201 using the mist collecting electrode 209. Thereby, the mist droplet 302 is prevented from landing on the substrate 11, and is collected near the nozzle surface 202, and the mist droplet 302 is prevented from landing at an area other than the required area.

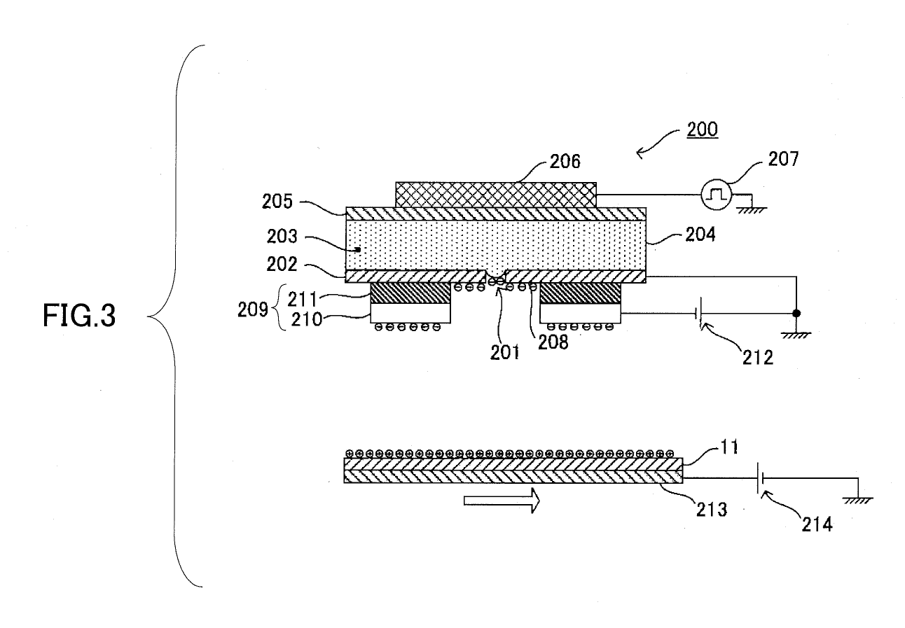

Next, using FIGS. 3, 4, 5, 6 and 7, a process of applying the PZT precursor solution using the droplet jet head 200 will be described in detail.

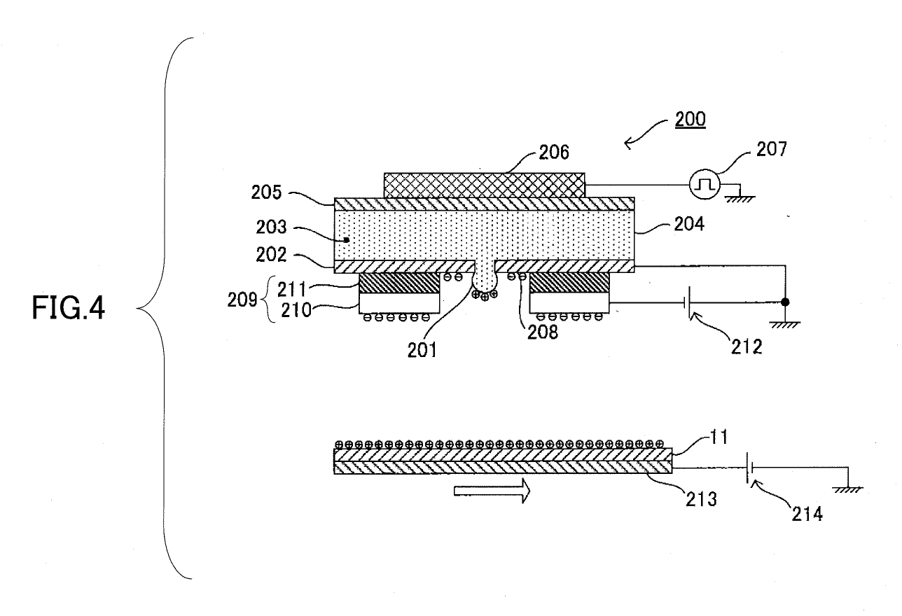

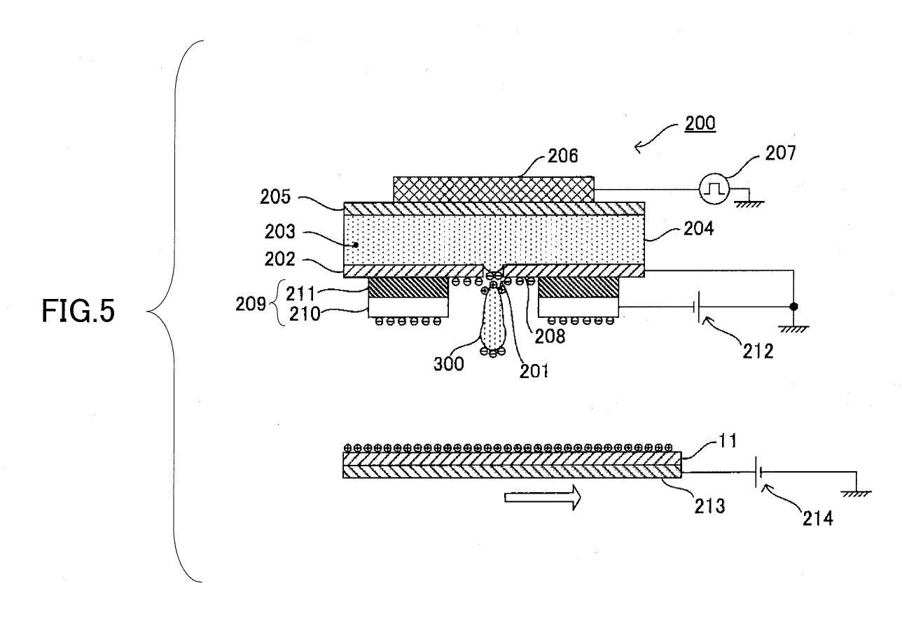

As shown in FIGS. 3, 4, 5, 6 and 7, by generating an electric potential difference between the nozzle surface 208 and the substrate 11, an electric field is generated at a space between the nozzle surface 208 and the substrate 11. FIG. 3 shows an ejection standby state in which no ejection driving signal for ejecting the PZT precursor solution 203 is applied to the piezoelectric element 206. Then, as shown in FIG. 4, in response to the ejection driving signal being output from the ejection driving power source 207, a projecting end of the PZT precursor solution 203, like a liquid column, projects to the outside from the nozzle hole 201. Then, as shown in FIG. 5, when a part 300 of the PZT precursor solution 203 is ejected to the electric field space between the nozzle surface 202 and the substrate 11, positive electrified ion molecules in the part 300 of the PZT precursor solution 203 are attracted by the nozzle surface 208 of the nozzle plate 202. Further, negative electrified molecules in the part 300 of the PZT precursor solution 203 move in a direction opposite to the nozzle surface 208 of the nozzle plate 202 because of repulsion against the positive electrified molecules. Thus, polarization occurs in the ejected part 300 of the PZT precursor solution 203. As shown in FIG. 5, the part 300 of the PZT precursor solution 203 ejected from the nozzle hole 201 is an applied droplet 300 that has been separated from the PZT precursor solution 203 that exists in the inside of the nozzle hole 201. When the applied droplet 300 is thus separated, the nozzle surface 208 of the nozzle plate 202 has the negative polarity. Thus, in the applied droplet 300 after being thus separated, the positive ion molecules are attracted to a part of the applied droplet 300 near the nozzle surface 208 of the nozzle plate 202, and the negative ion molecules are attracted to a part of the applied droplet 300 far from the nozzle surface 208 of the nozzle plate 202.

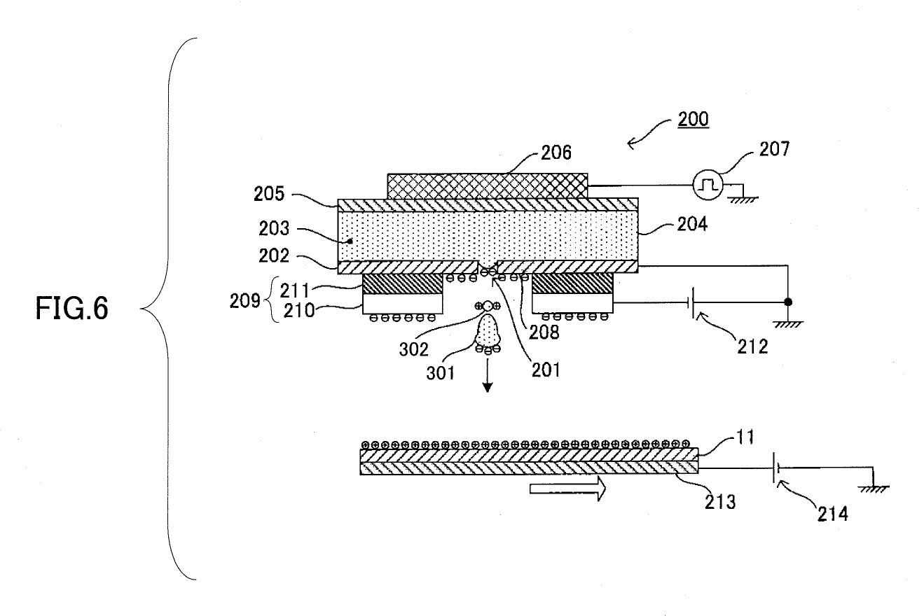

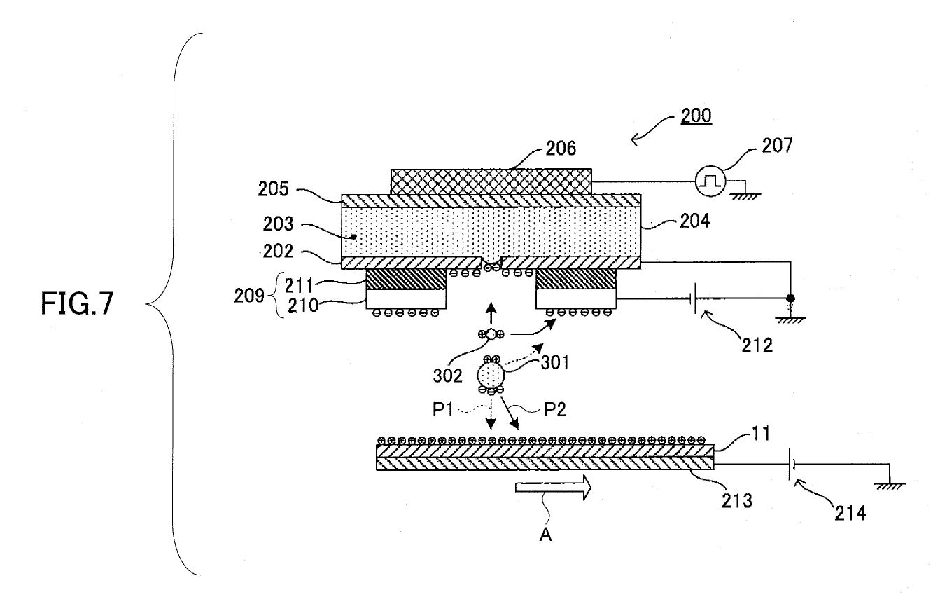

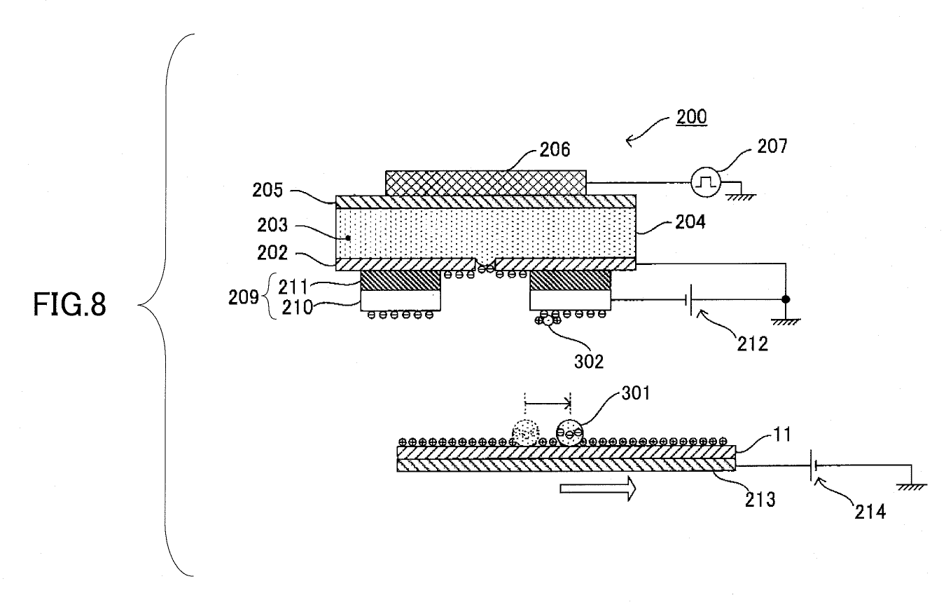

As a result, as shown in FIG. 6, the applied droplet 300 is divided into the chief droplet 301 and the mist droplet 302. The chief droplet 301 near the substrate 11 has the polarity opposite to the electrode 213, and the mist droplet 302 that has a smaller volume near the nozzle surface 208 has the same polarity as the electrode 213. The mist droplet 302 that has the smaller volume is easily decelerated by air resistance, and becomes mist. The diameter of the chief droplet 301 is on the order of 30 μm, and on the other hand, the diameter of the mist droplet 302 is on the order of several μm. Further, the velocity of the chief droplet 301 is 6 through 8 m/s, and on the other hand, the velocity of the mist droplet 302 is less than or equal to 4 m/s. As a result, as shown in FIG. 7, the mist droplet 302 is repelled by the electrode 213 because of coulomb force, and is attracted toward the nozzle surface 208. Simultaneously, since a stage (not shown) on which the substrate 11 is placed is moving in a direction indicated by an arrow A, the mist droplet 302 is moved from a position directly below the nozzle 201 toward the mist collecting electrode 209 by an air flow occurring because of the movement of the substrate 11 together with the stage. This is because the mist droplet 302 having the smaller volume is easily affected by a surrounding air flow. As a result, since the mist droplet 302 is electrified in the polarity opposite to the mist collecting electrode 209, the mist droplet 302 is attracted by and consequently collected by the mist collecting electrode 209, as shown in FIG. 8. On the other hand, as shown in FIG. 7, also in the chief droplet 301, ion molecules having the positive polarity opposite to the mist collecting electrode 209 are collected near the nozzle surface 208. Thus, the chief droplet 301 is also attracted by the mist collecting electrode 209 electrostatically. Further, in many cases, the division into the chief droplet 301 and the mist droplet 302 occurs near the nozzle surface 208. Thus, when the voltage is constantly applied to the mist collecting electrode 209 and the electric potential difference constantly occurs between the mist collecting electrode 209 and the nozzle plate 202, the column-like droplet 300 before being divided into the chief droplet 301 and the mist droplet 302 is affected not only by the first electrode (the electrode 213) but also by the electric field caused by the mist collecting electrode 209, and electrification of the mist droplet 302 may be remarkably reduced. As a result, the force of electrostatically attracting the mist droplet 302 toward the mist collecting electrode 209 is weakened, and thus, it may be difficult to control the movement of the mist droplet 302. Thus, the mist droplet 302 may easily adhere around the nozzle 201, and a flying direction of a droplet may be easily bent. As a result, the chief droplet 301 may land at a position (indicated by a solid arrow P2 in FIG. 7) shifted from the correct position (indicated by a broken arrow P1 in FIG. 7), and thus, a problematic situation may occur in which it is not possible to apply the PZT precursor solution to form the desired pattern.

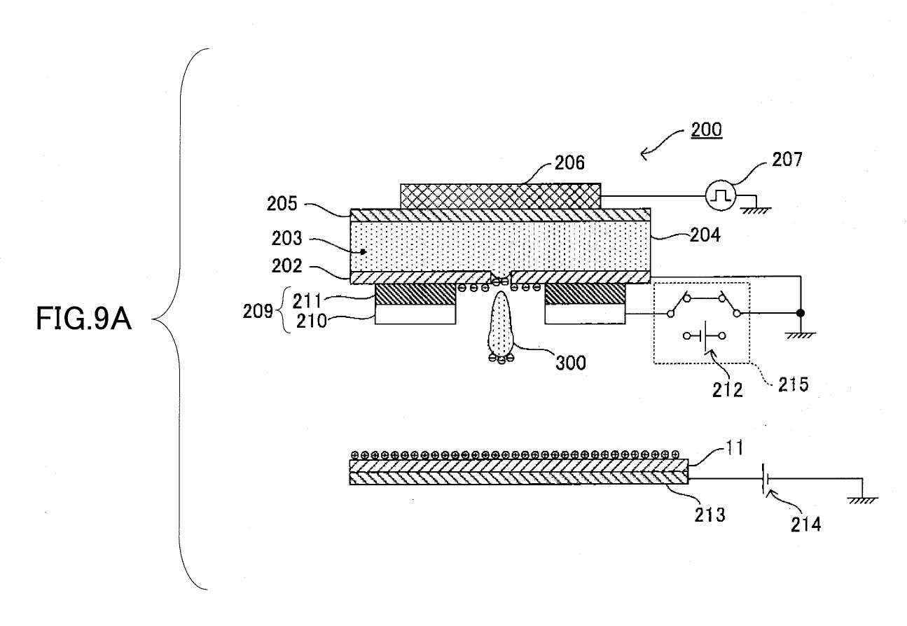

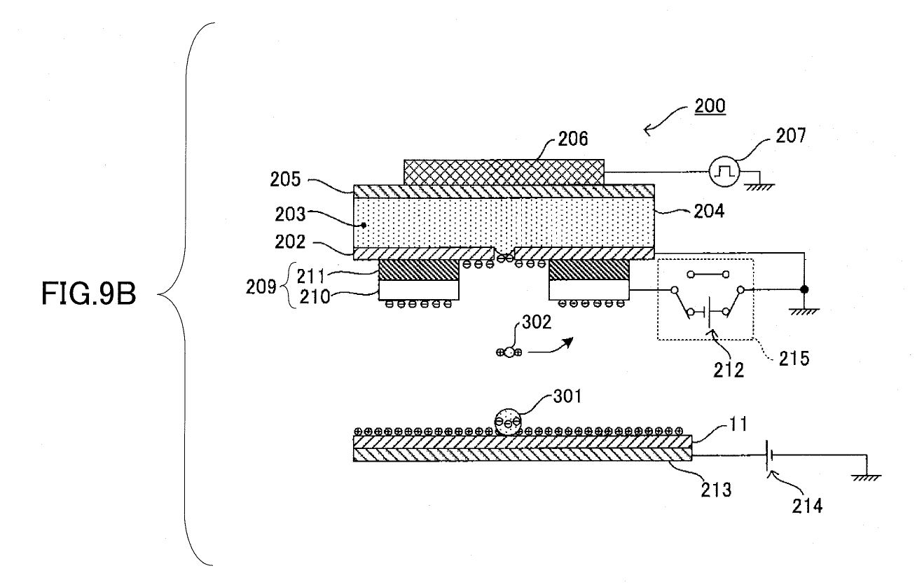

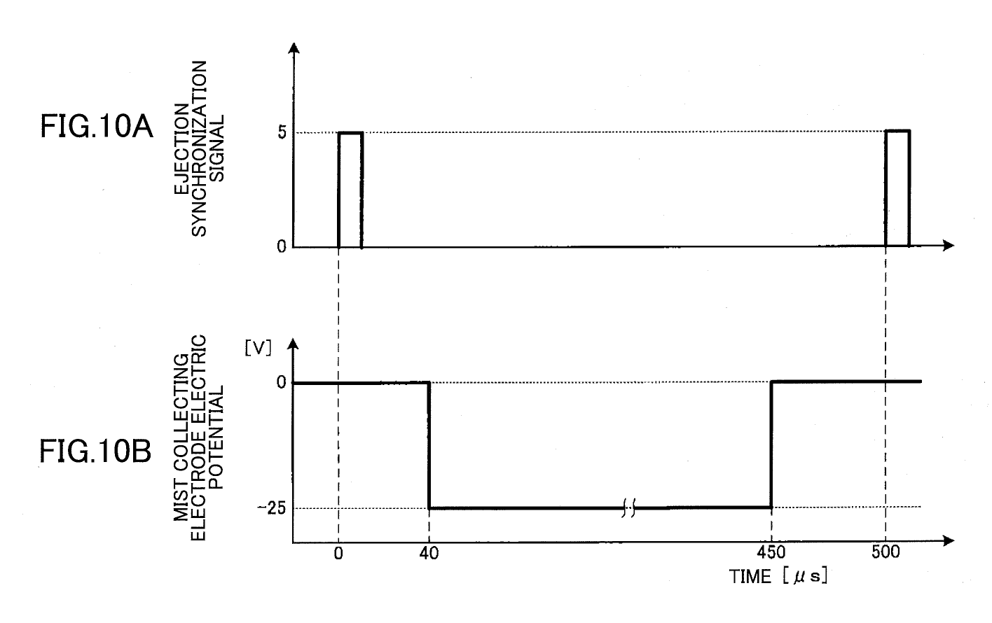

FIGS. 9A and 9B are sectional views showing switching control of a voltage to be applied to the mist collecting electrode 209. In FIGS. 9A and 9B, the same reference numerals as those of FIG. 2 indicate the same elements. As shown in FIG. 9A, the mist collecting electrode 209 is grounded by a voltage applying switching part 215 before the applied droplet 300 of the PZT precursor solution 203 is divided into the chief droplet 301 and the mist droplet 302. Then, as shown in FIG. 9B, after the applied droplet 300 of the PZT precursor solution 203 has been divided into the chief droplet 301 and the mist droplet 302 and the chief droplet 301 has then landed at the correct landing position, the voltage applying switching part 215 applies a voltage to the mist collecting electrode 209. Thereby, when the voltage is applied to the mist collecting electrode 209 by the voltage applying switching part 215, the chief droplet 301 has already landed at the correct landing position. Thus, the chief droplet 301 is prevented from being affected by the electrostatic force of the mist collecting electrode 209. Specifically, the connection of the contacts in the voltage applying switching part 215 is switched according to a switching signal given by a control part (not shown) after a predetermined period of time has elapsed from when the applied droplet 300 of the PZT precursor solution 203 has been ejected from the nozzle hole 301. For example, a case will be assumed where the time of the completion of the division of the chief droplet 301 from the mist droplet 302 is around after the elapse of 30 μs from the time of the ejection of the applied droplet 300, the pulse width of an ejection synchronization signal (see FIG. 10A) is 10 μs, and a period of ejection (a period of time between adjacent pulses of the ejection synchronization signal) is 500 μs. In such a case, a voltage (−25 V in FIG. 10B) may be applied to the mist collecting electrode 209 by the voltage applying switching part 215 at a timing such as that of signal waveforms shown in FIGS. 10A and 10B, i.e., after the elapse of 40 μs from when the pulse of the ejection synchronization signal has been supplied.

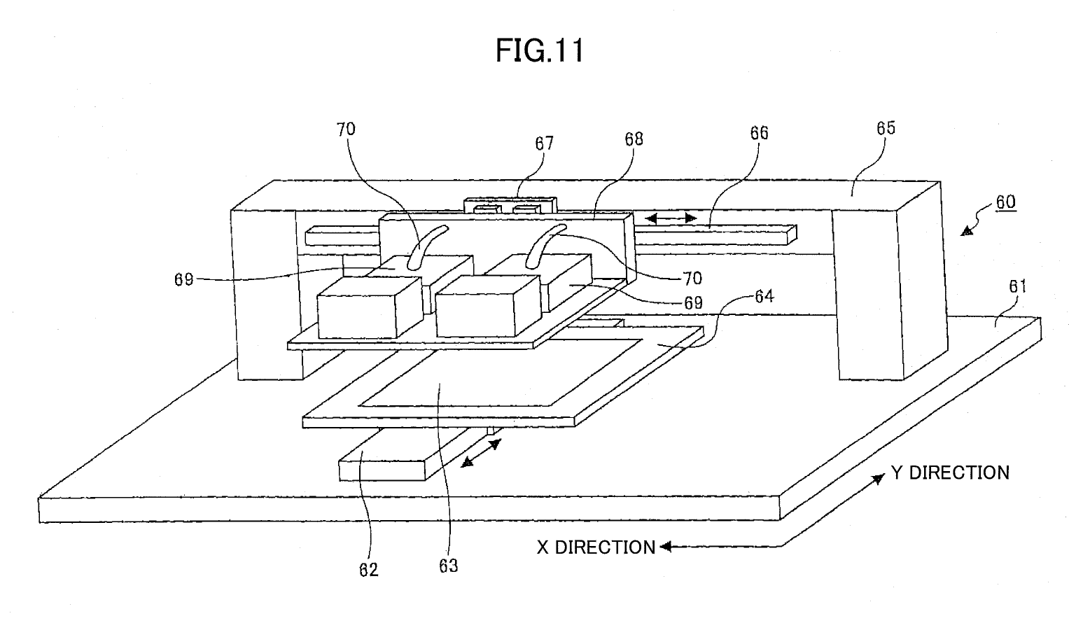

FIG. 11 is a perspective view showing a configuration of a droplet jet applying apparatus in which droplet jet heads according to the embodiments are mounted. In the droplet jet applying apparatus 60 shown in FIG. 11 in which the droplet jet heads 200 (“69” in FIG. 11) according to the embodiments are mounted, a Y-axis driving part 62 is installed on a mounting 61, and thereon, a stage 64 for mounting a substrate 63 (corresponding to the substrate 11 shown in FIGS. 2 through 8) is installed in such a manner that the stage 64 can be driven in the Y-axis directions. An attracting part using vacuum, static electricity or the like (not shown) is provided to accompany the stage 64, and the substrate 63 is fastened to the stage 64 by the attracting part. Further, an X-axis driving part 66 is mounted on an X-axis supporting member 65, and a Z-axis driving part 67 on which a head base 68 is mounted is mounted thereon. Thus, the head base 68 can be moved in the X-axis directions. On the head base 68, the droplet jet heads 69 that eject a liquid are mounted. The liquid (a PZT precursor solution) is supplied to the droplet jet heads 69 via supply pipes 70 from a liquid tank (not shown).

For the PZT precursor solution, as starting materials, lead acetate trihydrate, titanium isopropoxide and zirconium normal butoxide were used. Crystal water of lead acetate was dissolved in methoxyethanol, and then, was dehydrated to obtain a methoxyethanol solution. With respect to stoichiometric composition, the amount of lead was made to exceed 10 mol %. This was for the purpose of avoiding degradation in crystal properties which may occur due to a removal of lead during heat treatment. Titanium isopropoxide and zirconium normal butoxide were dissolved in methoxyethanol, alcohol exchange reaction and esterification reaction were allowed to proceed, and the titanium isopropoxide and zirconium normal butoxide were uniformly mixed with the above-mentioned methoxyethanol solution in which lead acetate was thus dissolved. Thus, the PZT precursor solution was synthesized. The PZT concentration of the PZT precursor solution was made to be 0.1 mol/l.

Next, more specific examples of the method of manufacturing a PZT film including the process of applying a PZT precursor solution with the droplet jet applying apparatus having the above-described configuration in which the droplet jet heads according to the embodiments are mounted will now be described.

### First Example

According to a first example of the embodiments, a surface modification process, an applying process, a drying process and a thermal decomposition process are carried out one time each, and thus, a PZT film of 100 nm having a predetermined pattern was obtained on a platinum electrode on a substrate 11. In the surface modification process, a SAM film 12 was partially formed (FIGS. 1B through 1D). In the applying process, a PZT precursor solution A (mentioned above) was selectively applied using the droplet jet applying apparatus having the above-described configuration in which the droplet jet heads are mounted. In the drying process, the applied PZT precursor solution A was dried at a predetermined temperature (120° C.). In the thermal decomposition process, the dried PZT precursor solution A was thermally decomposed at a predetermined temperature (500° C.). These surface modification process, applying process, drying process and thermal decomposition process were repeated 6 times, and thus, the film of 600 nm was obtained. After that, crystallization heat treatment (at a temperature of 700° C.) of thermally decomposing and crystallizing the thus obtained film was carried out by Rapid Thermal Annealing (RTA). Thus, a patterned PZT film as an electromechanical transducer film was formed on the platinum electrode of the substrate 11. As a result, a failure such as a crack did not occur in the PZT film. Further, as a result of mist droplets 302 being thus collected, a pattern failure of the PZT precursor solution being applied at a position other than the required pattern forming area did not occur.

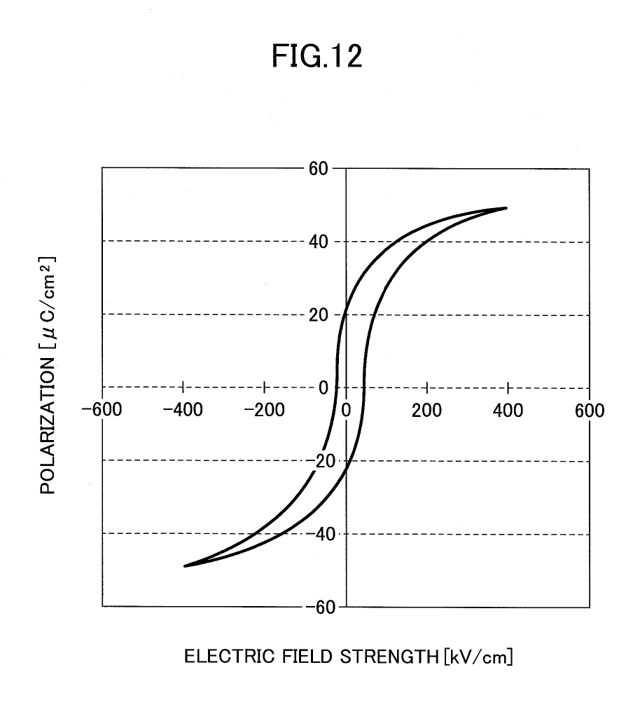

Further after that, the surface modification process, applying process, drying process (temperature: 120° C.) and thermal decomposition process (temperature: 500° C.) were repeated 6 times. After that, crystallization treatment was carried out. As a result, the film thickness of the PZT film reached 1000 nm without causing a failure such as a crack. Then, an upper electrode (second electrode) made of platinum was formed on the thus obtained patterned PZT film by sputtering, and an electromechanical transducer element was formed. Then, an evaluation for electric characteristics and electric-mechanical transducing performance (piezoelectric constant) was carried out. As a result, a P (polarization)−E (electric field strength) hysteresis curve of FIG. 12 was obtained. Further, the dielectric constant of the PZT film was 1220; the dielectric loss was 0.02, the residual polarization was 19.3 μC/cm², and the coercive electric field was 36.5 kV/cm. Thus, it is seen that the PZT film has characteristics equivalent to a common ceramic sintered compact. Further, the electric-mechanical transducing performance was calculated as a result of a deformation amount that resulted from applying an electric field being measured by a laser Doppler vibrometer and calibration being carried out using simulation. The piezoelectric constant d31 was 120 pm/V, and this is also equivalent to a ceramic sintered compact. This value is a characteristic value with which a piezoelectric element to be used in a droplet jet head can be satisfactorily designed.

On the other hand, without providing the upper electrode (second electrode) made of platinum, a further increase in film thickness of the PZT film was tried. That is, a 6-time repetition of a surface modification process, an applying process, a drying process (temperature: 120° C.) and a thermal decomposition process (temperature: 500° C.), and crystallization treatment thereafter, were repeated 10 times. As a result, a patterned PZT film of a total film thickness of 5 μm could be obtained without causing a defect such as a crack.

### Second Example

According to a second example of the embodiments, the droplet jet applying apparatus shown in FIG. 11 was used to form the above-mentioned upper electrode (second electrode) made of platinum, and a liquid that included a platinum material was applied only at a required area on the PZT film, and the applied liquid was dried. The other processes were carried out in manners the same as or similar to those of the above-mentioned first example of the embodiments. When the liquid that includes the platinum material was applied, the contrast of a contact angle could be used in a manner the same as or similar to that mentioned above for applying the PZT precursor solution, and thus an applying area therefor could be defined. At a time of forming the upper electrode, it was necessary to apply the liquid to an area smaller than that of the pattern of the PZT film, in order to avoid short circuit. For this purpose, according to the second example of the embodiments, instead of the above-mentioned method of using the contrast of a contact angle, lift-off technology was used. Thus, resist was patterned at an area at which the upper electrode made of platinum was not to be formed. Then, the liquid that includes the platinum material was applied to the surface of the PZT film on which the resist pattern had been thus formed. Then, after drying treatment was carried out on the platinum at 120° C., the resist was removed. Thus, the platinum was made to remain only at the area other than the area at which the resist had been thus removed. Then, finally, sintering at 250° C. was carried out on the platinum film. The film thickness thereof after the sintering was 0.5 μm, and the specific resistance (volume resistivity) was 5×10⁻⁶ Ω·cm.

Also in the second example of the embodiments, the same as or similar to the above-mentioned first example of the embodiments, it was possible to form a PZT film as a patterned electromechanical transducer film having a desired film thickness without including cracks. Also, as a result of mist droplets 302 being thus collected, a pattern failure of the PZT precursor solution being applied at a position other than the required pattern forming area did not occur.

### Third Example

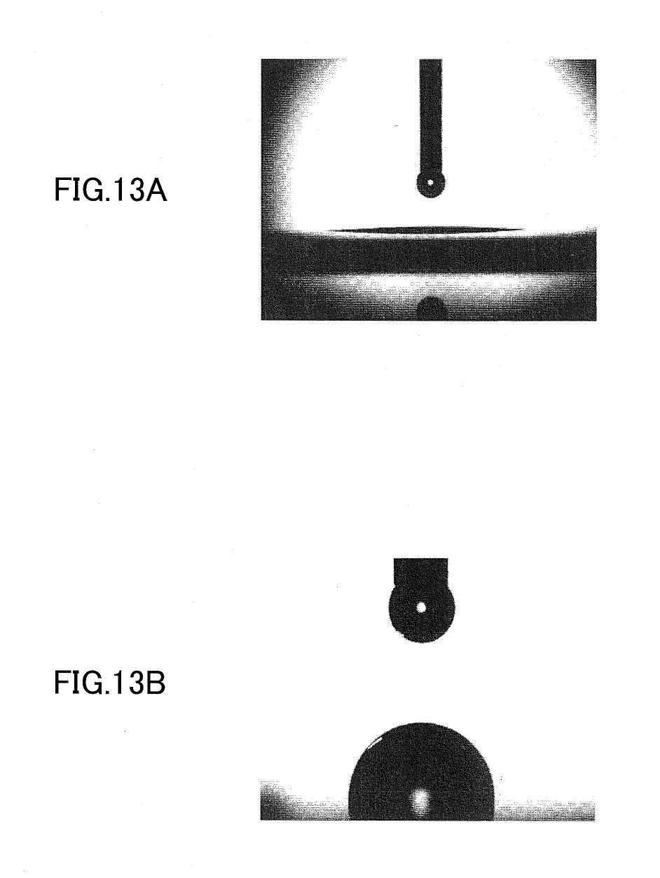

According to a third example of the embodiments, as electrode films of other platinum group elements for the lower electrodes (first electrodes), ruthenium, iridium and rhodium were used to form films by sputtering on silicon wafers that have thermal oxide films on which titanium adhesion layers were placed, respectively. The other processes that include a process of forming a SAM film 12 were carried out in the manners the same as or similar to those of the first example of the embodiments. Further, a film of platinum-rhodium alloy (the concentration of rhodium was 15 wt %) was also formed by sputtering as an electrode film of a platinum group alloy for the lower electrode (first electrode). Further, also a sample was used in which an iridium metal or a platinum film was placed on an iridium oxide film. When these materials were used to form the lower electrodes (first electrodes), the contact angle of pure water on the electrode exposed surface after the SAM films 12 was removed was less than or equal to 5° (perfect wet) for every sample (see FIG. 13A). On the other hand, the contact angle of pure water on the surface, on which the SAM film 12 was placed as it was, was on the order of 90° for every sample (see FIG. 13B).

Further, also according to the third example of the embodiments, the same as or similar to the first example of the embodiments, a patterned PZT film as an electromechanical transducer film having a desired film thickness without cracks could be formed. Further, as a result of mist droplets 302 being thus collected, a pattern failure of the PZT precursor solution being applied at a position other than the required pattern forming area did not occur.

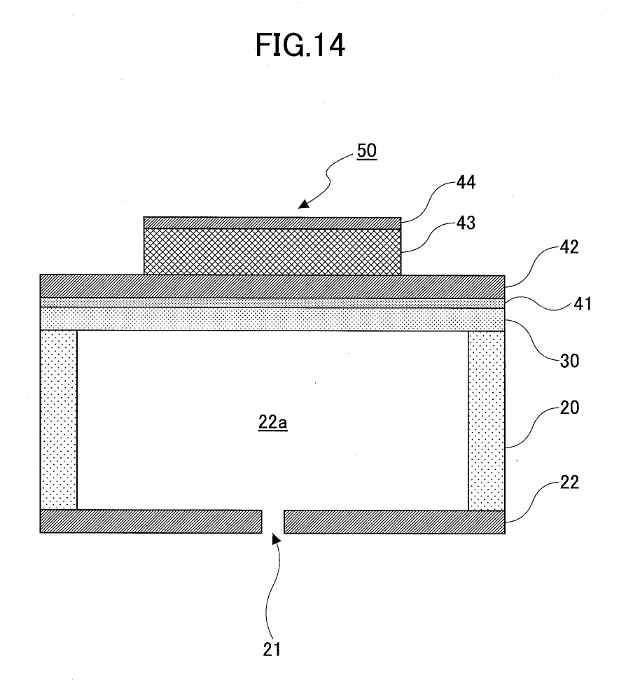

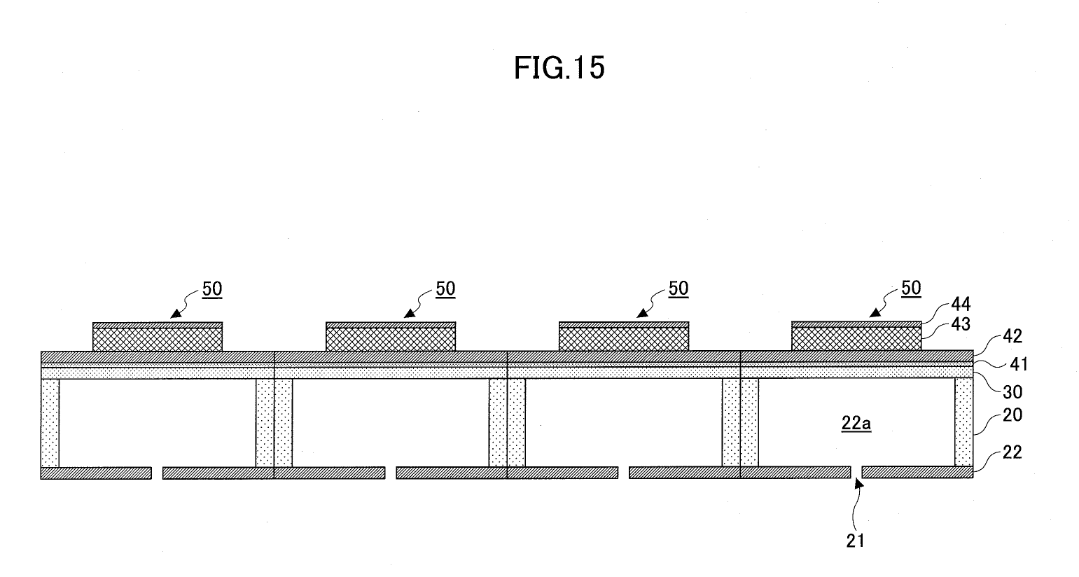

FIG. 14 shows a general configuration of one example of a droplet jet head that includes an electromechanical transducer element (PZT element) manufactured by any one of the above-mentioned manufacturing methods of the embodiments. In the example shown in FIG. 14, on a silicon substrate 20 being a liquid chamber substrate, a vibration plate 30, an adhesion layer 41 and a lower electrode (first electrode) 42 can be superposed, one by one, in sequence, in layers. Then, at a predetermined area on the lower electrode (first electrode) 42, an electromechanical transducer element (PZT element) 43 that has performance equivalent to bulk ceramics and an upper electrode 44 can be formed in a manner of patterning them according to any one of the above-mentioned simple manufacturing methods of the embodiments. After that, a liquid chamber 22a is formed as a result of removing a part of the silicon substrate 20 by an etching process from the back side (the bottom side in FIG. 14), and a nozzle plate 22 that has a nozzle hole 21 is bonded. Thus, the droplet jet head 50 can be manufactured. It is noted that in FIG. 14, a liquid supply part, a flow path and a fluid resistance part are omitted for the purpose of simplification of explanation. Further, plural of the droplet jet heads 50 of FIG. 14 may be arranged as shown in FIG. 15.

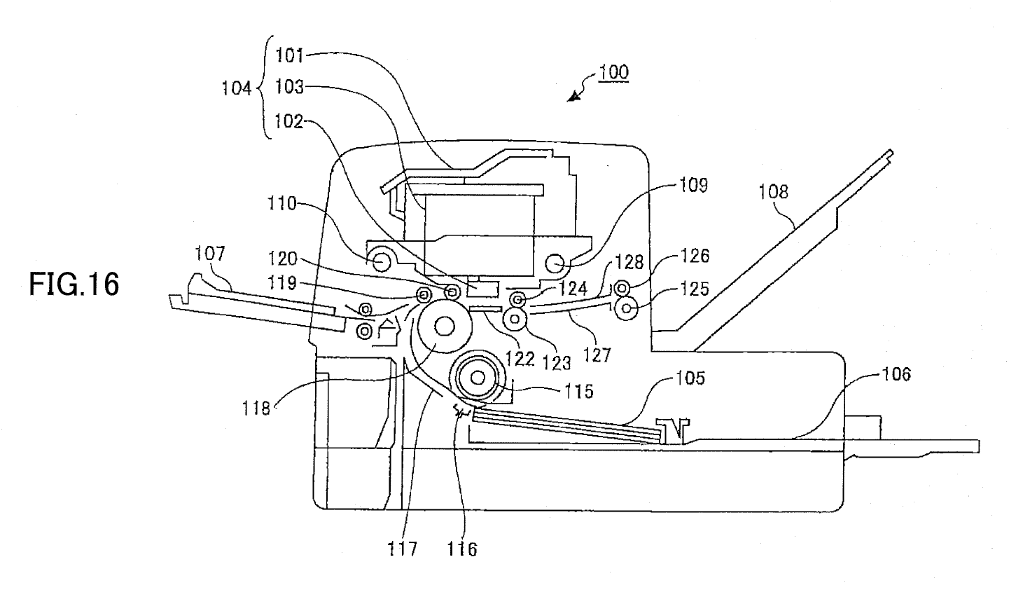

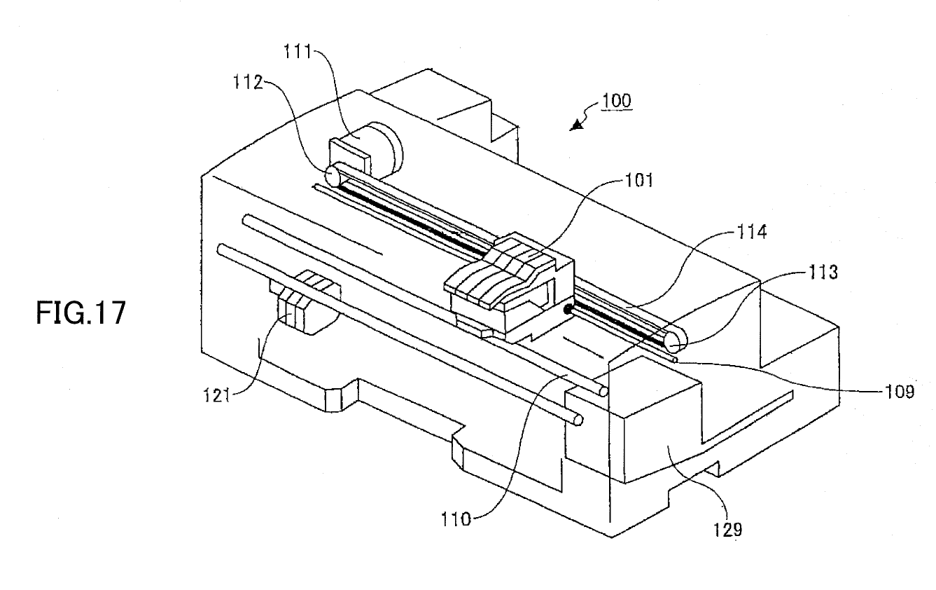

FIG. 16 shows a general configuration of an inkjet recording apparatus 100 that is one example of a droplet jet apparatus that can use electromechanical transducer elements manufactured by any one of the above-mentioned manufacturing methods according to the embodiments. FIG. 17 is a general perspective see-through view of the inkjet recording apparatus 100. In the inkjet recording apparatus 100 shown in FIGS. 16 and 17, that is one example of a droplet jet apparatus, droplet jet heads are mounted which have elecromechanical transducer elements that are manufactured by the method of manufacturing an elecromechanical transducer element according to any one of the above-described embodiments. An inkjet recording apparatus 100 that is one example of a droplet jet apparatus according to any one of the embodiments includes a printing mechanism part 104 that includes a carriage 101, a recording head 102, and ink cartridges 103. The carriage 101 is movable in main scan directions in the inside of the body of the inkjet recording apparatus 100. The recording head 102 includes inkjet heads that are examples of droplet jet heads manufactured by the method according to any one of the embodiments, and is mounted in the carriage 101. The ink cartridges 103 supply inks to the recording head 102. In a lower part of the body of the inkjet recording apparatus 100, a paper supply cassette 106 which holds many sheets of paper 105 is detachably loaded from the front side. Further, a manually inserting tray 107 for manually inserting a sheet of paper 105 can be opened from the body of the inkjet recording apparatus 100. A sheet of paper 105 supplied and sent from the paper supply cassette 106 or the manually inserting tray 107 is taken in, and a desired image is recorded on the sheet of paper 105 by the printing mechanism part 104. Thereafter, the sheet of paper 105 is ejected to a paper ejection tray 108 that is attached at the back side of the body of the inkjet recording apparatus 100.

In the printing mechanism part 104, the carriage 101 is held slidably in the main scan directions by a main guide rod 109 and an auxiliary guide rod 110, which are guiding members and are horizontally laid between left and right side plates (not shown). In the carriage 101, the recording head 102 is loaded, which includes the inkjet heads that are examples of droplet jet heads according to any one of the embodiments. The inkjet heads eject ink droplets having respective colors of yellow (Y), a cyan (C), magenta (M) and black (Bk). The recording head 102 is loaded in the carriage 101 in such a manner that plural ink ejection holes (nozzles or nozzle holes) are arranged in a direction that intersects the main scan directions, and the ink ejection directions are downward directions. Further, in the carriage 101, the respective ink cartridges 103 for supplying the inks of the respective colors are exchangeably loaded. The ink cartridges 103 have atmosphere holes at upper parts for communicating with the atmosphere and have supply holes for supplying the inks to the recording head 102 at a lower part. The ink cartridges 103 have porous members in the insides which are filled with the inks, and, because of capillary force of the porous members, the inks to be supplied to the recording head 102 are kept at slightly negative pressure.

As mentioned above, the inkjet heads of the respective colors are used in the recording head 102. However, the recording head 102 may have a single inkjet head that has nozzles that eject ink droplets of the respective colors. As shown in FIG. 16, the main guide rod 109 is inserted in a back side (the downstream side of the paper conveyance direction) part of the carriage 101 slidably. A front side (the upstream side of the paper conveyance direction) part of the carriage 101 is slidably placed on the auxiliary guide rod 110. In order to make it possible to move the carriage 101 in the main scan directions for main scanning operations, as shown in FIG. 17, a timing belt 114 is laid between a driving pulley 112 driven and rotated by a main scan motor 111 and a driven pulley 113, the timing belt 114 is fixed to the carriage 101, and thus, the carriage 101 is driven in a to-and-fro manner as a result of forward and reverse rotations of the main scan motor 111.

In order to convey a sheet of paper 105 that is previously set in the paper supply cassette 106 to a position below the recording head 102, a paper supply roller 115 and a friction pad 116; a guide member 117; a conveyance roller 118; and a conveyance roller 119 and a leading edge roller 120 are provided. The paper supply roller 115 separates the sheet of paper 105 from the paper supply cassette 106 and the friction pad 116 supplies and sends the sheet of paper 105. The guide member 117 guides the sheet of paper 105. The conveyance roller 118 reverses and conveys the supplied sheet of paper 105. The conveyance roller 119 is pressed onto the conveyance roller 118, and the leading edge roller 120 controls the sending out angle of the sheet of paper 105 conveyed by the conveyance roller 118. The conveyance roller 118 is driven and rotated by a sub-scan motor 121 through a train of gears. A printing reception member 122 is provided to correspond to a moving range of the carriage 101 in the main scan directions, and acts as a paper guide member for guiding the sheet of paper 105 sent from the conveyance roller 118 below the recording head 102. A conveyance roller 123 and a spur 124, driven and rotated, are provided on the downstream side of the paper conveyance direction of the printing reception member 122 for sending out the sheet of paper 105 to a paper ejection direction. Further, a paper ejection roller 125 and a spur 126 are provided for further sending out the sheet of paper 105 to the paper ejection tray 108, and guide members 127 and 128 are provided to create a paper ejection path.

At a time of recording, the recording head 108 is driven according to a given image signal while the carriage 101 is being moved. Thus, inks are ejected onto the sheet of paper 105 that is stopped, and a line of an image is recorded thereon. Then, the sheet of paper is conveyed by a predetermined amount, and then, another line of the image is recorded in the same way. When a recording finish signal or a signal indicating that the back end of the sheet of paper 105 has reached at a recording area is generated, the recording operations are terminated, and the sheet of paper 105 is ejected.

Further, at a position outside of the recording area at the right end of the moving direction of the carriage 101 (in FIG. 17), a recovery unit 129 is provided for recovering the recording head 102 from an ink ejection failure problem. The recovery unit 129 has a capping part, a suction part and a cleaning part (not shown). The carriage 101 is moved toward the recovery unit 129 during a printing standby state, and the capping part caps the recording head 102. Thus, the ink ejection holes of the recording head 102 are kept moist, and thus, the recording head 102 is prevented from having an ink ejection failure due to drying of ink. Further, during recording operations or the like, by causing the recording head 102 to eject inks not relevant to recording, it is possible to keep the ink viscosity constant in the all of the ink ejection holes, and maintain the stable ink ejection performance.

The configurations described above are examples, and embodiments have unique advantageous effects for the following respective modes.

### (Mode A)

In a collecting process, after a droplet of an applying liquid is ejected from a nozzle hole 201, a voltage is applied to an accompanying droplet collecting electrode by a voltage applying part after a predetermined period time has elapsed. Thus, an accompanying droplet is collected. As described above for the embodiments, in a process of ejecting an applying droplet 300 of an applying liquid (PZT precursor solution) 203 from the nozzle hole 201 and selectively applying it at a predetermined area on a first electrode of a substrate 11 for forming an elecromechanical transducer film (PZT film), a small accompanying droplet (mist droplet) 302 that accompanies a chief droplet 301 may be generated after the applied droplet 300 of the applying liquid 203 is ejected from the nozzle hole 201, and the chief droplet 301 may head toward the first electrode ahead of the accompanying droplet (mist droplet) 302. In consideration of such a situation, a voltage is applied to the accompanying droplet collecting electrode (mist collecting electrode) 209 after a predetermined period of time has elapsed from when the applied droplet 300 of the applying liquid (PZT precursor solution) 203 has been ejected from the nozzle hole 201. The predetermined period of time is determined to be in a range such that the accompanying droplet (mist droplet) 302 divided from the applied droplet 300 of the applying liquid (PZT precursor solution) 203 ejected from the nozzle hole 201 does not reach the first electrode, and also, the accompanying droplet (mist droplet) 302 can be collected by the accompanying droplet collecting electrode (mist collecting electrode) 209 as a result of the voltage applying part starting to apply a voltage to the accompanying droplet collecting electrode (mist collecting electrode) 209 at a point of time the predetermined period of time has elapsed. By thus delaying the timing of starting to apply a voltage to the accompanying droplet collecting electrode (mist collecting electrode) 209 from the droplet ejection by the predetermined period of time, it is possible to shorten the period of time during which the chief droplet 301 receives the electrostatic force by the electric field of the accompanying droplet collecting electrode (mist collecting electrode) 209 to which the voltage has been applied. Also, the accompanying droplet (mist droplet) 302 is collected by the accompanying droplet collecting electrode (mist collecting electrode) 209 before reaching the first electrode. Thus, the chief droplet 301 ejected from the nozzle hole 201 can be applied at a predetermined part of a desired pattern on the first electrode. Also, the unnecessary accompanying droplet 302 that accompanies the chief droplet 301 can be prevented from adhering to the first electrode. Thus, it is possible to prevent unnecessary droplets from adhering to an electrode when ejecting an applying liquid that includes a raw material for forming an elecromechanical transducer film and applying it onto the electrode. Also, it is possible to form the elecromechanical transducer film having a desired pattern.

### (Mode B)

After the elecromechanical transducer film having a predetermined film thickness has been formed on the first electrode according to the method of manufacturing an electromechanical transducer film according to the above-described “mode A”, a second electrode placing process is carried out for placing a second electrode to sandwich the elecromechanical transducer film with the first electrode. Thereby, as described above for the embodiments, it is possible to place the second electrode to sandwich the elecromechanical transducer film with the first electrode, after forming the patterned electromechanical transducer film having the predetermined film thickness on the first electrode without allowing mist droplets 302 to adhere to the first electrode. Thus, it is possible to manufacture an electromechanical transducer element of high quality.

### (Mode C)

The second electrode placing process in the above-described “mode B” may include a process of applying an electrode-forming applying liquid at a predetermined area on the elecromechanical transducer film according to a droplet ejection method of ejecting from a nozzle a droplet of the electrode-forming applying liquid that includes a raw material for forming the second electrode. Thereby, as described above for the embodiments, it is possible to easily place the patterned second electrode only on the surface of the electromechanical transducer film, by applying the electrode-forming applying liquid at a predetermined area on the electromechanical transducer film, according to the droplet ejection method of ejecting from a nozzle a droplet of the electrode-forming applying liquid that includes a raw material for forming the second electrode.

### (Mode D)

In the above-described “mode B” or “mode C”, the first and second electrodes may be made of platinum group elements, oxides thereof or laminated films including some or all of these materials. Thereby, as described above for the embodiments, it is possible to form the first electrode having a satisfactory hydrophilic surface, and also, it is possible to easily place the second electrode using the droplet ejection method.

### (Mode E)

An electromechanical transducer element may be manufactured in the method of manufacturing an electromechanical transducer element according to any one of the above-described “mode B”, “mode C” and “mode D”. Thereby, as described above for the embodiments, it is possible to manufacture the electromechanical transducer element of high quality.

### (Mode F)

A droplet jet head may include the elecromechanical transducer element of the above-mentioned “mode E”. Thereby, as described above for the embodiments, it is possible to manufacture the droplet jet head of high quality.

### (Mode G)

A droplet jet apparatus may include the droplet jet head of the above-mentioned “mode F”. Thereby, as described above for the embodiments, it is possible to manufacture the droplet jet apparatus in which a droplet ejection failure can be avoided and stable droplet ejection performance can be maintained.

According to the embodiments, when an applying liquid including a raw material for forming an electromechanical transducer film is ejected from a nozzle and is applied selectively at a predetermined area on a first electrode, a voltage is applied to an accompanying droplet collecting electrode by a voltage applying part after a predetermined period of time has elapsed from when an applied droplet of the applying liquid has been ejected from the nozzle. The applied droplet ejected from the nozzle may be divided into a chief droplet and an accompanying droplet, and the chief droplet may head toward the first electrode ahead of the accompanying droplet. Thus, the predetermined period of time is determined in such a range that the accompanying droplet divided from the applied droplet of the applying liquid ejected from the nozzle will not reach the first electrode, and also, the accompanying droplet can be collected by the accompanying droplet collecting electrode as a result of starting to apply the voltage to the accompanying droplet collecting electrode at the point of time the predetermined period of time has elapsed. By thus delaying the start of applying the voltage to the accompanying droplet collecting electrode by the predetermined period of time from the ejection of the applied droplet, it is possible to shorten a period of time during which the chief droplet receives the electrostatic force from the electric field of the accompanying droplet collecting electrode to which the voltage is applied, and also, to collect the accompanying droplet by the accompanying droplet collecting electrode before the accompanying droplet reaches the first electrode. Thus, it is possible to prevent an unnecessary droplet from adhering to the electrode, and also, to form the elecromechanical transducer film having a desired pattern.

Thus, according to the embodiments, it is possible to prevent an unnecessary droplet from adhering to an electrode when ejecting an applying liquid including a raw material for forming an electromechanical transducer film from a nozzle and applying it to the electrode, and also it is possible to form the electromechanical transducer film having a desired pattern.

The method of manufacturing an elecromechanical transducer film, the method of manufacturing an elecromechanical transducer element, the elecromechanical transducer element manufactured by the method, the droplet jet head and the droplet jet apparatus have been thus described by the embodiments. However, the present invention is not limited to these embodiments, and variations and modifications may be made without departing from the scope of the present invention.

The present application is based on Japanese Priority Applications No. 2011-188998 filed Aug. 31, 2011 and No. 2012-180843 filed Aug. 17, 2012, the entire contents of which are hereby incorporated herein by reference.

What is claimed is:

1. A method of manufacturing an electromechanical transducer film, the method comprising:
selectively applying an applying liquid to a predetermined area on a first electrode by a droplet ejection method of ejecting from a nozzle the applying liquid including a raw material for forming the elecromechanical transducer film;
drying a film of the applying liquid applied onto the first electrode; and
thermally decomposing and crystallizing the dried film of the applying liquid, wherein
the applying the applying liquid includes applying a voltage to an accompanying droplet collecting electrode that collects a small accompanying droplet that accompanies a chief droplet of the applying liquid ejected from the nozzle, and the voltage has a polarity opposite to that of the accompanying droplet and is applied to the accompanying droplet collecting electrode by a voltage applying part so that the accompanying droplet is electrostatically attracted by the accompanying droplet collecting electrode and is collected before reaching the first electrode, and
the applying the voltage to the accompanying droplet collecting electrode and collecting the accompanying droplet include applying the voltage to the accompanying droplet collecting electrode by the voltage applying part after a predetermined period of time has elapsed from when a droplet of the applying liquid has been ejected from the nozzle, and collecting the accompanying droplet.

2. A method of manufacturing an electromechanical transducer element, comprising:
after forming an elecromechanical transducer film having a predetermined film thickness on a first electrode according to the method of manufacturing an electromechanical transducer film claimed in claim 1, placing a second electrode to sandwich with the first electrode the elecromechanical transducer film formed on the first electrode.

3. The method of manufacturing an electromechanical transducer element as claimed in claim 2, wherein
the placing the second electrode includes applying an electrode-forming applying liquid at a predetermined area on the elecromechanical transducer film according to a droplet ejection method of ejecting a droplet of the electrode-forming applying liquid that includes a raw material for forming the second electrode.

4. The method of manufacturing an electromechanical transducer element as claimed in claim 2, wherein
the first and second electrodes are made of platinum group elements, oxides thereof or laminated films including some or all of these materials.

5. An electromechanical transducer element, manufactured according to the method of manufacturing an electromechanical transducer element claimed in claim 2.

6. A droplet jet head, comprising:
the electromechanical transducer element claimed in claim 5.

7. A droplet jet apparatus, comprising:
the droplet jet head claimed in claim 6.
